(19) United States
(12) Patent Application Publication
(10) Pub. No.: US 2013/0044085 A1
(43) Pub. Date: Feb. 21, 2013

(54) Liquid crystal panel driving circuit and liquid crystal display Device Using the Same

(71) Applicants: Poshen Lin, Shenzhen (CN); Xiaoping Tan, Shenzhen (CN); Yuhua Chang, Shenzhen (CN)

(72) Inventors: Poshen Lin, Shenzhen (CN); Xiaoping Tan, Shenzhen (CN); Yuhua Chang, Shenzhen (CN)

(21) Appl. No.: 13/263,897

(22) PCT Filed: Sep. 5, 2011
(86) PCT No.: PCT/CN2011/079350

§ 371 Date: Oct. 11, 2011

(30) Foreign Application Priority Data
Aug. 16, 2011 (CN) 201110234070.X

(51) Int. Cl. G09G 5/00

(52) U.S. Cl. 345/204

(57) ABSTRACT

The present invention discloses a liquid crystal panel driving circuit and a liquid crystal display (LCD) device using the same, multiple scan chips and multiple discharge resistors which are corresponding to all the scan chips one-to-one, wherein each said discharge resistor is used for loading the scan drive and the scan line of the corresponding scan chip. Because the loading resistor group of the clipper circuit is divided into multiple discharge resistors which are matched with all the scan chips, the discharge energy will be reduced as long as each discharge resistor is responsible for the loading of the corresponding scan chip, and the problem of local overheating will not be generated. In addition, the discharge resistors can be distributed into different positions; the arrangement of the driving circuit can be freely selected; the heat is uniformly dissipated by distributing the discharge resistors, and local overheating will be avoided and not affect the performance of the circuit.

### TECHNICAL FIELD

The present invention relates to the field of liquid crystal displays (LCDs), particularly to a liquid crystal panel driving circuit and a LCD device using the same.

### BACKGROUND

In the LCD driving structure, the clipper circuits are widely used to reduce the feed-through voltage effect and the line distortion. FIG. 1 shows a liquid crystal driving circuit with a clipper circuit, and said liquid crystal driving circuit comprises a data driving circuit and a scan driving circuit. Three MOSFET field effect transistors as switch assembly are used by the clipper control circuit. When the level of the sequence closing signal GVOFF of the sequence control circuit 2 is high, the switch PQ8 is turned on, and the DC power supply VGHP for driving the thin-film transistor (TFT) gate is generated by the DC module 1 and then is output to the scan driving circuit 4. When the level of the continuity signal GVON of the sequence control circuit 2 is high, the switch of the QP7 B passage is turned on; the gate-on voltage VGH is discharged by grounding the loading resistor group 8 (RP43, RP44); the voltage is reduced; and a clipped wave is formed, and the waveform of the overall circuit is shown in FIG. 2. Because the loading resistor group 8 bears all the electric current in the conduction period of the continuity signal GVON, the temperature of the loading resistor group 8 will be gradually increased because the loading end has many charges. When the heat is not dissipated in time with the increase of the update frequency, the synergistic effect is produced and the temperature further increases. Thus, in the prior art, many large-size resistors in parallel connection are selected and used, and large-area heatsink devices are paved at the bottom of the resistors to disperse the heat uniformly, so that the resistors do not burn out. However, the close arrangement of the resistors in this mode will still elevate the temperature of the area, and affect the performance and the service life of the driving circuit.

### SUMMARY

The aim of the present invention is to provide a liquid crystal panel driving circuit and a LCD device using the same with better heat dissipation performance.

The purpose of the present invention is achieved by the following technical schemes.

A liquid crystal panel driving circuit comprises multiple scan chips, wherein said liquid crystal panel driving circuit also comprises multiple discharge resistors which are used for loading the scan chips and are corresponding to all the scan chips one-to-one. Said discharge resistors are arranged between the input end of each scan chip and the ground.

Preferably, the output end of each said scan chip is formed with parasitic capacitors.

Preferably, each said discharge resistor is a variable resistor with adjustable resistance. Because the parasitic capacitors of each branch of the open scan chip are different, the preferable adjusting effect can be achieved only when the slope of the gate-on voltage VGH is matched with the corresponding DC parasitic capacitor. The slope of the gate-on voltage VGH of the corresponding branch can be conveniently adjusted by adjusting the resistance of the discharge resistor of each branch, and then the generality can be increased.

Preferably, said variable resistor is a digital control variable resistor, and said liquid crystal panel driving circuit also comprises a digital controller for controlling the resistance of the digital control variable resistor. The digital control variable resistor can conveniently control the resistance of the variable resistor by digital signals, achieving the aim of automatically adjusting the resistance of the discharge resistor and improving the intellectualization of the circuit.

Preferably, said liquid crystal panel driving circuit also comprises a digital memory which is connected with said digital controller. Said digital controller stores the received serial data and serial clock signal into the digital memory, and adjusts the resistance of the digital control variable resistor in accordance with the information stored in the digital memory. This is the specific control mode for controlling the digital control variable resistor by the digital memory.

Preferably, each said discharge resistor is integrated into the corresponding scan chip thereof. The scheme can improve the integrity of the circuit. In addition, when the parasitic capacitor of the gate-on voltage VGH in the branch is calculated, because each discharge resistor is integrated into each scan chip and the distance between the discharge resistor and the scan chip is the nearest, the calculated value approximates to the actual value; the calculated value of the parasitic capacitor affects the adjustment of the discharge resistor and the slop of the plateaus of the clipped wave of the gate-on voltage VGH. The closer the calculated value to the actual value is, the better the adjusting effect of the gate-on voltage VGH is.

Preferably, said liquid crystal panel driving circuit comprises a DC module for providing power supply for said scan chip, and said liquid crystal panel driving circuit also comprises a sequence control circuit, one or more first switching circuits and second switching circuits, wherein said first switching circuit is positioned between the output end of said DC module and said scan chip; each said second switching circuit is positioned between the discharge resistor and the ground; the control ends of said first switching circuit and the second switching circuit are coupled with said sequence control circuit. This is an embodiment for fitting the clipper circuit of the present invention. The distributed switching circuits are used to achieve the functions of the clipper circuit so that the cost can be reduced. In addition, the liquid crystal panel driving circuit has the advantages of simple structure design, fewer components, reduction of area occupied by PCB plate and high reliability of circuit operation.

Preferably, each said second switching circuit is integrated into the corresponding scan chip thereof. The integrity of the circuit can be improved, and wiring can be simplified.

Preferably, a voltage stabilizing circuit is in series connection between each said discharge resistor and each said second switching circuit; one end of said voltage stabilizing circuit is connected with the discharge resistor, and the other end is connected with the ground through said second switching circuit. The voltage stabilizing circuit can stabilize the voltage of the gate-on voltage VGH in the discharge process, to ensure that the gate-on voltage VGH has sufficient voltage for driving the thin-film transistor (TFT).

A LCD device, wherein said LCD device comprises the aforementioned liquid crystal panel driving circuit.

Because the loading resistor group of the gate-on voltage VGH is divided into multiple discharge resistors which are matched with all the scan chips, and the number of the discharge resistors is the same as that of said scan chips, the discharge energy of each discharge resistor will be reduced as long as each discharge resistor is responsible for the loading of its corresponding scan chip, and the problem of overheating will be hardly generated. In addition, the discharge resistors can be distributed into different positions; the arrangement of the driving circuit can be freely selected; the heat is uniformly dissipated by distributing the discharge resistors, and then the performance and the service life of the circuit affected by overheating can be avoided.

### BRIEF DESCRIPTION OF FIGURES

FIG. 1 is the block diagram of the prior art;

FIG. 2 is the diagram of the waveform of the control signal;

FIG. 3 is the block diagram of the present invention;

FIG. 4 is the block diagram of the liquid crystal panel of the present invention;

FIG. 5 is the block diagram of the grounded circuit of the discharge resistor with voltage stabilizing circuit of the present invention;

FIG. 6 is the block diagram of the grounded circuit of the discharge resistor integrated into the scan chip of the present invention; and

FIG. 7 is the block diagram of the resistance of the digital control resistor of the present invention. Wherein:

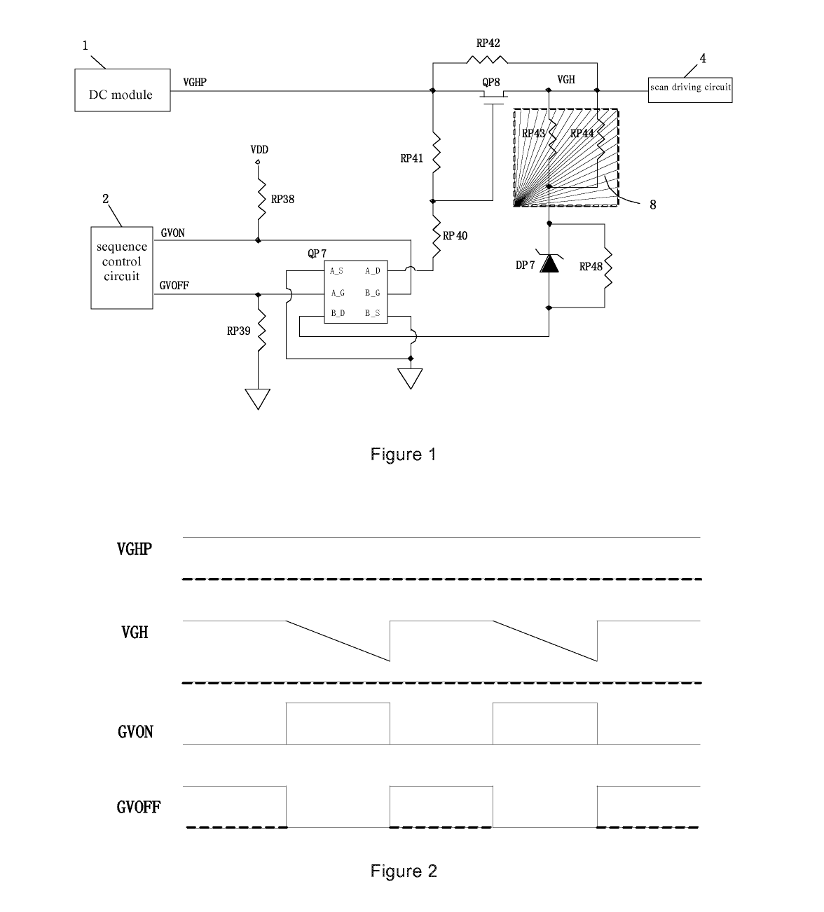

1. direct module; 2. sequence control circuit; 3. discharge resistor; 4. scan driving circuit; 5. first switching circuit; 6. second switching circuit; 7. scan chip; 8. loading resistor group; 9. digital controller; 10. digital memory.

### DETAILED DESCRIPTION

The present invention will further be described in detail in accordance with the figures and the preferred embodiments.

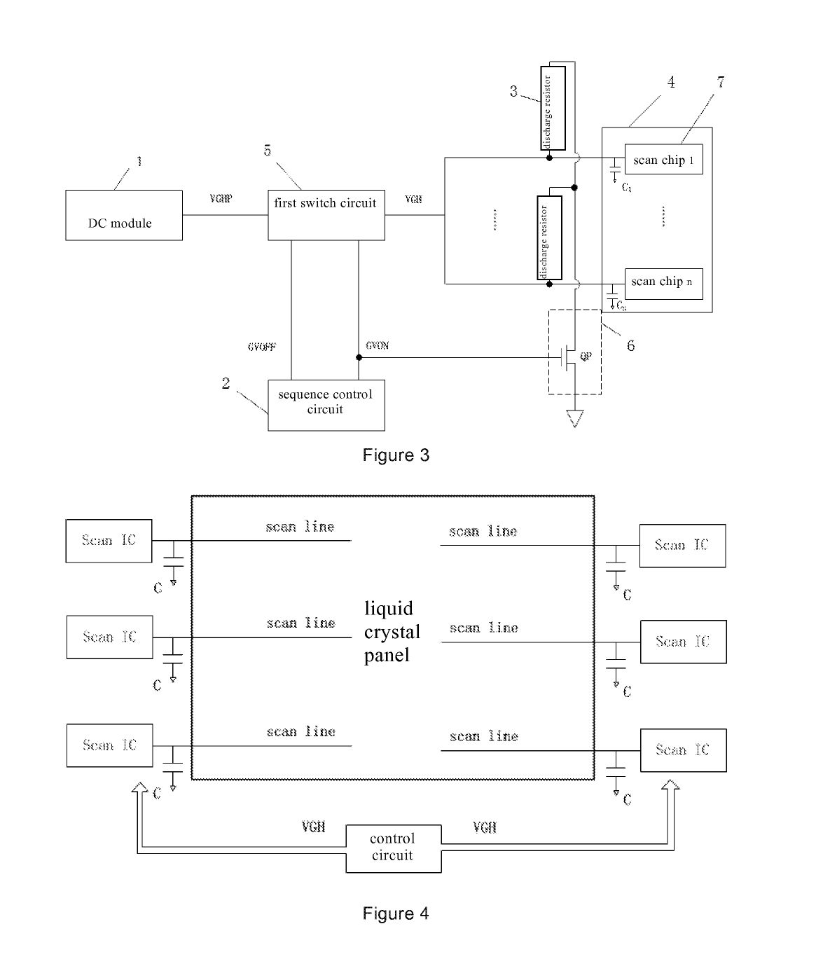

As shown in FIG. 3 and FIG. 4, the liquid crystal panel driving circuit of the embodiment comprises a DC module 1 and a scan driving circuit 4 connected to the output end of said DC module 1, wherein said scan driving circuit 4 comprises multiple scan chips 7; the output end of said DC module 1 is respectively connected with each scan chip 7 to form multiple branches; said liquid crystal panel driving circuit also comprises discharge resistors which are used for loading the scan chips and are corresponding to all the scan chips one-to-one. Said discharge resistors are arranged between the input end of each scanning chip and the ground. The present invention can also comprise one or more first switch circuits 5 and second switch circuits 6, wherein said first switch circuit 5 is positioned between the output end of said DC module 1 and the scan chip 7; and said second switch circuits is positioned between the discharge resistors 3 and the ground.

The liquid crystal driving circuit generally comprises a sequence control circuit 2, and the sequence control circuit 2 periodically and alternately produces opening signal GVON and closing signal GVOFF in accordance with the transmitted video frame signals. In the embodiment, each the first switch circuit 5 and the second switch circuit 6 are controlled by the two signals. When the level of the closing signal GVOFF of the sequence control circuit 2 is high, the first switch circuit 5 is turned on and the second switch circuit 6 is turned off, and the gate-on voltage VGH output by the first switch circuit 5 is equal to the VGHP of the DC power supply. When the level of the sequence continuity signal GVON of the sequence control circuit 2 is high, the first switch circuit 5 is turned off and the second switch circuit 6 is turned on, and the gate-on voltage VGH is discharged by grounding the discharge resistors 3; the voltage is gradually reduced, and a clipped waveform is formed. The gate-on voltage VGH is loaded into the scanning line by the scan chips 7 and then is used for driving the TFT. Said second switching circuit 6 can turn on or turn off the components by using the relay, triode, field effect transistor, etc. The present invention uses the field effect transistor as the example (hereafter referred to as switch QP) to explain the second switch. The source electrode of the switch QP is connected with said discharge resistor 3; the drain electrode is connected with the ground; and the grid electrode is connected with the sequence continuity signal GVON of the sequence control circuit 2. When the level of the sequence continuity signal GVON is high, the level of the sequence closing signal GVOFF is low; the first switch circuit 5 is turned off; the switch QP is turned on; the gate-on voltage VGH is discharged through the discharge resistor 3; and the voltage is gradually reduced; when the level of the sequence closing signal GVOFF of the sequence control circuit 2 is high, and the level of the sequence continuity signal GVON is low; the first switch circuit 5 is turned on; the QP is turned off; the gate-on voltage VGH stops discharging and recovers to the voltage of the DC power supply VGHP. By alternately turning on/turning off the first switch circuit 5 and the switch QP, the gate-on voltage VGH forms the clipped wave as shown in FIG. 2.

The number of the discharge resistors 3 is the same as that of the scan chips 7, and each discharge resistor 3 is only responsible for the discharge of the gate-on voltage VGH of the branch of the scan chips 7. Thus, the heat dissipation of the individual discharge resistor 3 is obviously reduced, and the overall heat dispersion is improved.

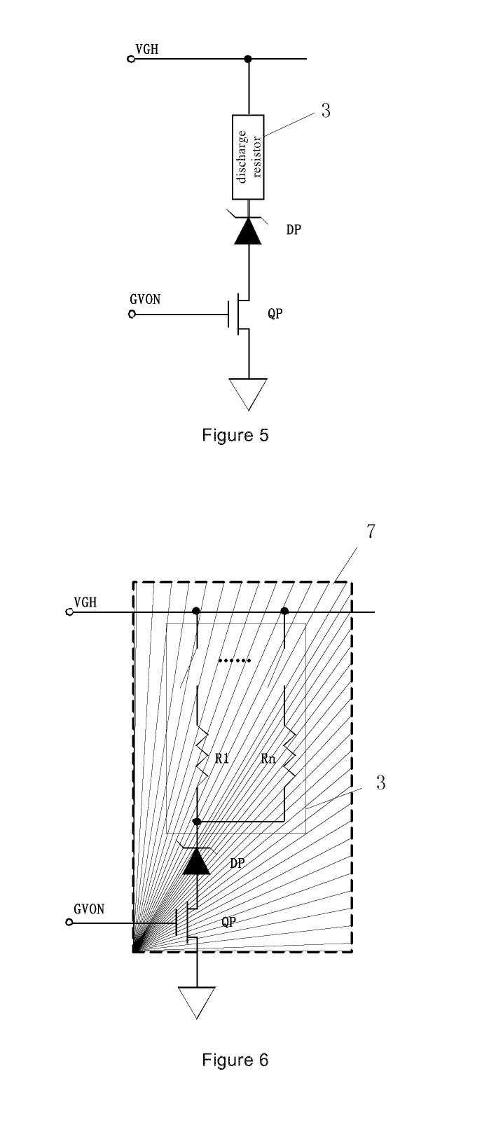

In addition, as shown in FIG. 5, the voltage stabilizing circuit can be added to the grounded circuit of the discharge resistor 3, and can be used for limiting the cut-off voltage when the gate-on voltage VGH discharges. Take the voltage stabilizing diode DP as an example, the cathode of the voltage stabilizing diode DP is connected to said discharge resistor 3, and the anode of the voltage stabilizing diode DP is connected to the source electrode of the switch QP. When the switch PQ is turned on, the anode of the voltage stabilizing diode DP is connected to the ground, to achieve the normal access of the voltage stabilizing circuit. The reverse breakdown voltage of said voltage stabilizing diode DP should be selected in accordance with the driving voltage amplitude value required by the thin-film transistor, to ensure that the minimum discharge voltage of the gate-on voltage VGH can drive the thin-film transistor.

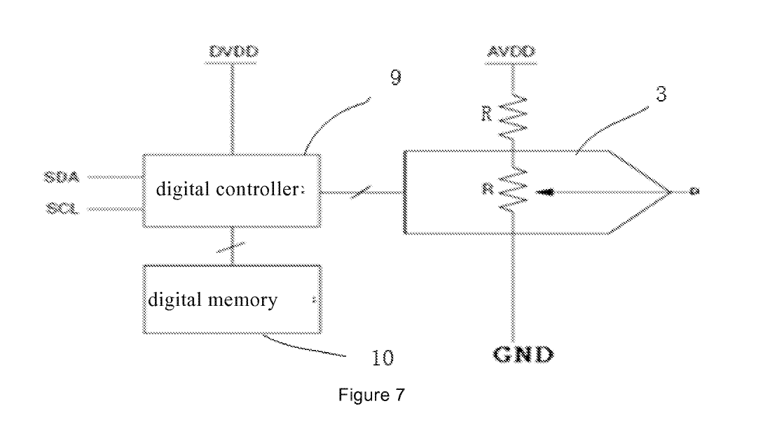

In addition, as shown in FIG. 6, each said discharge resistor 3 is an adjustable resistor. Because path lengths and the cabling modes, etc. of all gate-on voltage VGH branches connected to the scan chips 7 are different, the impedance and condensance which are generated by each branch are different. Particularly, the difference of the impedance and the condensance of all branches is more obvious with the increase of the frame size and the improvement of the update frequency; therefore, adjustment is required for the slop of the plateaus of the clipped wave of the gate-on voltage VGH to match with the parasitic capacitor of the corresponding branch, so that the ideal clipped waveform can be obtained. The slop of the plateaus of the clipped wave of the gate-on voltage VGH can be changed by changing the resistance of the discharge resistor 3. As shown in FIG. 7, take the discharge resistor 3 controlled by the digital control variable resistor as an example. The control circuit comprises a digital controller 9, wherein the digital controller 9 uses the I²C communication mode to receive the series data (SDA) of the main control chip and the series clock (SCL) signal and stores the signal into the digital memory 10. Said digital control variable resistor comprises a plurality groups of resistors which are in parallel connection; each group of resistors are in series connection with a control switch; and the control end of the digital control variable resistor is connected with said digital controller 9. The turning on and turning off of each switch are controlled by receiving the data of the digital controller 9, and the resistance of the resistor to be used is set, and then the slop of the plateaus of the clipped wave of the gate-on voltage VGH of the branch is adjusted.

In order to simplify the circuit and save the development and production time, each discharge resistor 3 can be integrated into each scan chip 7. If the discharge resistor 3 is an adjustable resistor, the resistance of the discharge resistor 3 can be adjusted when in use in accordance with the parasitic capacitor of the branch, and the application range of the scan chip 7 can be expanded. In addition, when the discharge resistor 3 is integrated into the scan chip 7, the distance between the discharge resistor 3 and the scan chip 7 is the nearest, and the calculated branch parasitic capacitor approximates to the actual value. Therefore, the adjusting effect is the best. Similarly, said voltage stabilizing circuit and the second switching circuit 6 can be integrated into the interior of the scan chip 7, so that the integrity of the circuit can be further increased, and the development and production time can be further saved.

Because the loading resistor group 8 of the gate-on voltage VGH is divided into multiple discharge resistors which are matched with all the scan chips, and the number of the discharge resistors is the same as that of said scan chips, the discharge energy of each discharge resistor will be reduced as long as each discharge resistor is responsible for loading its corresponding scan chip, and the problem of overheating will be hardly generated . In addition, the discharge resistors can be distributed into different positions; the arrangement of the driving circuit can be freely selected; the heat is uniformly dissipated by distributing the discharge resistors; and then the performance and the service life of the circuit affected by local overheating can be avoided.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A liquid crystal panel driving circuit, comprising: multiple scan chips, and multiple discharge resistors which are corresponding to all the scan chips one-to-one and are used for loading the scan chips.

2. The liquid crystal panel driving circuit of claim 1, wherein the output end of each said scan chip is formed with parasitic capacitor.

3. The liquid crystal panel driving circuit of claim 2, wherein each said discharge resistor is a variable resistor with adjustable resistance.

4. The liquid crystal panel driving circuit of claim 3, wherein said variable resistor is a digital control variable resistor, and said liquid crystal panel driving circuit also comprises a digital controller for controlling the resistance of the digital control variable resistor.

5. The liquid crystal panel driving circuit of claim 4, wherein said liquid crystal panel driving circuit also comprises a digital memory which is connected with said digital controller, and said digital controller stores the received serial data and serial clock signal into the digital memory, and adjusts the resistance of said digital control variable resistor in accordance with the information stored in the digital memory.

6. The liquid crystal panel driving circuit of claim 2, wherein each said discharge resistor is integrated into the corresponding scan chip thereof.

7. The liquid crystal panel driving circuit of claim 1, wherein said liquid crystal panel driving circuit comprises a DC module for providing power supply for said scan chip; said liquid crystal panel driving circuit also comprises a sequence control circuit, one or more first switching circuits and second switching circuits, wherein said first switching circuit is positioned between the output end of said DC module and said scan chip; each said second switching circuit is positioned between said discharge resistors and the ground; and the control end of said first switching circuit and the second switching circuit is coupled with said sequence control circuit.

8. The liquid crystal panel driving circuit of claim 7, wherein each said second switching circuit is integrated into the corresponding scan chip thereof.

9. The liquid crystal panel driving circuit of claim 7, wherein a voltage stabilizing circuit is in series connection between said discharge resistor and said second switching circuit; one end of said voltage stabilizing circuit is connected with the discharge resistor, and the other end is connected with the ground through said second switching circuit.

10. A liquid crystal display (LCD) device, comprising: a liquid crystal panel driving circuit;
said liquid crystal panel driving circuit comprises multiple scan chips and multiple discharge resistors which are corresponding to all the scan chips one-to-one and are used for loading the scan chips.

11. The LCD device of claim 10, wherein the output end of each said scan chip is formed with parasitic capacitor.

12. The LCD device of claim 11, wherein each said discharge resistor is a variable resistor with adjustable resistance.

13. The LCD device of claim 12, wherein each said variable resistor is a digital control variable resistor, and said liquid crystal panel driving circuit also comprises a digital controller for controlling the resistance of the digital control variable resistor.

14. The LCD device of claim 13, wherein said liquid crystal panel driving circuit also comprises a digital memory which is connected with said digital controller; said digital controller stores the received serial data and serial clock signal into the digital memory, and adjusts the resistance of the digital control variable resistor in accordance with the information stored in the digital memory.

15. The LCD device of claim 11, wherein each said discharge resistor is integrated into the corresponding scan chip thereof.

16. The LCD device of claim 10, wherein said liquid crystal panel driving circuit comprises a DC module for providing power supply for said scan chip; said liquid crystal panel driving circuit also comprises a sequence control circuit, one or more first switching circuits and second switching circuits, wherein said first switching circuit is positioned between the output end of said DC module and said scan chip; said second switching circuit are positioned between the discharge resistors and the ground; and the control end of said first switching circuit and the second switching circuit is coupled with said sequence control circuit.

17. The LCD device of claim 16, wherein each said second switching circuit is integrated into the corresponding scan chip thereof.

18. The LCD device of claim 16, wherein a voltage stabilizing circuit is in series connection between said discharge resistors and said second switching circuits; one end of said voltage stabilizing circuit is connected with the discharge resistor, and the other end is connected with the ground through said second switching circuits.
